(19) United States
(12) Patent Application Publication
(10) Pub. No.: US 2002/0178783 A1
(43) Pub. Date: Dec. 5, 2002

(54) Multi-gas delivery system

(76) Inventors: Chris Miller, North Vancouver (CA); Steven Fairbanks, Alberta (CA); John W.H. Miller, Alberta (CA)

Correspondence Address: Terry M Gerstein, 1015 Salt Meadow Lane, McLean, VA, 22101, US

(21) Appl. No.: 10/148,967

(22) PCT Filed: Dec. 6, 2000
(86) PCT No.: PCT/CA00/01435

(30) Foreign Application Priority Data
Dec. 8, 1999 (CA) 2.292128

(51) Int. Cl. G01N 7/00

(52) U.S. Cl. 73/23.2; 222/3; 222/71

(57) ABSTRACT

A system for regulating and monitoring the delivery of a flow of a gas from a gas source to an output flow of a gas delivery device, wherein the gas is comprised of at least one specialty gas and preferably greater than one specialty gas. The system comprises a delivery unit and a sampling unit. The delivery unit is connectable with the gas source and the output flow of the gas delivery device for delivering the flow of the gas from the gas source to the output flow at an injection site defined thereby, wherein the delivery unit is comprised of an adjustable device for regulating the flow of the gas therethrough. The sampling unit is connectable with the output flow of the gas delivery device at a location downstream of the injection site for removing a gas sample from the output flow, wherein the sampling unit is comprised of a sample monitoring device for providing feedback on the composition of the gas sample. Preferably, the feedback is provided on a continuous basis.

### FIELD OF INVENTION

This invention pertains to a system, kit or device for regulating and monitoring the delivery of a gas comprised of at least one specialty gas, and preferably two or more specialty gases. The system is useable with various means, mechanisms or devices for administering any variety of specialty gases. For instance, the system is usable with any gas delivery device such as any mechanically assisted ventilation device, mechanism or ventilator and associated ventilatory pattern. Further, the gas delivery device may be any spontaneous ventilation device, mechanism or ventilator and associated ventilatory pattern. For example, the spontaneous ventilator may be comprised of a gas proportioning device that provides a flow to the subject.

### BACKGOUND OF THE INVENTION

The administration of specialty gases, and in particular specialty gases used for medical purposes, is broadening. Early use of helium as a carrier gas for oxygen in the treatment of upper airway stridor is recently being investigated with renewed vigor. Nitric oxide, initially studied for its vasodilator effects, may also have unexpected uses in the treatment of sickle cell anemia, tuberculosis and other medical applications. Specialty gases, such as carbon monoxide, may have similar beneficial effects as nitric oxide and may in fact have synergistic therapeutic advantages. Inhaled carbon dioxide administration may be of use for acutely treating symptoms of various cardiac anomalies. Thus, there is a need for a system, kit or device for regulating and monitoring the delivery of these specialty gases in medicine to a patient in need thereof.

As indicated, helium has been used as a carrier gas for oxygen instead of nitrogen. As well, a mixture of 80% helium and 20% oxygen may prove beneficial in the treatment of status asthmaticus or airway stridor. The low density of helium enables the gas to bypass constricted airways. At the same time, the helium carries some oxygen, thus preventing atelectasis and relieving hypoxia. To date, a combined helium regulating and monitoring delivery system has not been available and is thus needed to accomplish this therapy.

Titration of nitric oxide into gas delivery devices or systems has been described in the literature. For instance, initial multicenter trials to determine safety and effectiveness of inhaled nitric oxide have utilized this technique. In near continuous gas delivery devices, such as neonatal/pediatric ventilators, high frequency oscillators and mask therapy, nitric oxide can be titrated into the inspiratory limb or output flow of the gas delivery device using a small continuous injection. The expected nitric oxide concentration can be calculated as [NO]=(NO flow×source ppm)÷(NO flow+gas delivery system flow). However, levels of specialty gases, such as nitric oxide, nitrogen dioxide and oxygen, need to be monitored closely and this calculation provides an approximation only. Presently, equipment utilized to accomplish the required monitoring includes rotometers, large cylinders and stand-alone nitric oxide, nitrogen dioxide and oxygen monitors. Although this equipment tends to be inexpensive, it is also large and bulky. Hence, it is not conducive for transport. Further, this equipment is dedicated to the delivery of nitric oxide and cannot be used for any other specialty gas delivery.

Gas delivery devices or systems which have large fluctuations and/or phasic flow may require inspiratory phase injection. This method is described as automatic and maintains a set nitric oxide concentration as entered by the user. Although this method appears popular, it is controversial whether the resultant dose has a greater advantage over small continuous injection technique. To be sure, this technique requires a sophisticated flow sensing device and consequently is not cost effective for most applications. For mask therapy, given to a spontaneously breathing subject, this system is not required. This device has been adapted for transport but weighs over 90 pounds. Again, this system has been designed specifically for inhaled nitric oxide therapy and does not have multi-gas capabilities.

Further, preliminary basic medical research suggests that carbon monoxide may have similar attributes as nitric oxide within the pulmonary vasculature. In fact, some data shows that nitric oxide in conjunction with carbon monoxide may have beneficial synergistic use as an inhalational gas. Studies are being planned to evaluate its effectiveness. However, research in this area will likely be problematic as there is no delivery device in existence.

Oxygen-carbon dioxide delivery may be used to stimulate deep breathing and to relieve cerebral vascular spasm. This gas mixture may be of use for acutely treating symptoms of various cardiac anomalies. Close observation and monitoring of this gas mixture within the intensive care or operating room has not been possible in the past. Thus, a device or system is needed to safely deliver and to regulate and monitor the gas mixture.

Specialty medical gas therapy is expanding. Until research proves out the safety and effectiveness of new gas mixtures, a dedicated delivery system or device is not justified. The future may require new gas mixtures and sensors for research. A device or system designed for flexibility to accommodate the regulated delivery and monitoring of a variety of gas mixtures is needed.

Further, specialty gas mixtures are often difficult to maintain in a cylinder. Specifically, the stability and half life of these gases are short. To date, only large cylinders have been available for use. Rarely is a large volume of specialty gas needed and these cylinders sit or are wasted. This may result in a dangerous or expensive situation due to time lag between use. Specialty gases available in small volume (approximately 100 liters) high-pressure cylinders with easy to change, quick connect fittings, would be extremely useful, safe and cost effective.

A wide variety of delivery systems, specific to a certain medical gas therapy and a particular specialty gas have been devised in prior art. Problems with these existing systems or devices are that they are gas specific and have limited multiple gas capability. They also tend to be bulky, expensive, and not conveniently and easily transportable.

Background information relating to the present invention may be found in the following patents: U.S. Pat. No. 4,127,121 issued November, 1978 to Westenskow; U.S. Pat. No. 4,191,952 issued March, 1980 to Schreiber; U.S. Pat. No. 4,328,823 issued May, 1982 to Schreiber; U.S. Pat. No. 4,336,798 issued June, 1982 to Beran; U.S. Pat. No. 4,345,612 issued August, 1982 to Koni; U.S. Pat. No. 4,442,856 issued April, 1984 to Betz; U.S. Pat. No. 4,611,590 issued September, 1986 to Ryschka; U.S. Pat. No. 4,770,168 issued September, 1988 to Rusz; U.S. Pat. No. 5,159,924 issued November, 1992 to Cegielski; U.S. Pat. No. 5,197,462 issued March, 1993 to Falb; and U.S. Pat. No. 5,558,083 issued September, 1996 to Duncan.

Further background information relating to the present invention may be found in the following references:

Respiratory Technology Procedure and Equipment Manual, Hunsinger D. L., Lisnerski K. J., Maurizi J. J., Philips M. L. Reston Publishing Company, Inc., 1980;

Betit P, Adatia I, Benjamin P, Thompson J. E., Wessel D. L. Inhaled nitric oxide: evaluation of a continuous titration delivery technique for infant mechanical and manual ventilation. Respir Care 1995; 40(7):706-715;

The Neonatal Inhaled Nitric Oxide Study Group. Inhaled nitric oxide in full-term and nearly full term infants with hypoxic respiratory failure. The New England Journal of Medicine 1997; 336(9):597-604;

Skimming J. W., Blanch P. B., Banner M. J. Behavior of nitric oxide infused at constant flow rates directly into a breathing circuit during controlled mechanical ventilation. Crit Care Med 1997;25:1410-1416;

Kliewer K, Hill W. Noport-a portable nitric oxide delivery system. Abstract. Resp Care 1996; 40(10):941;

1. Martell R. Nitric oxide and nitrogen dioxide pulse with the Infant Star ventilator. Can J RespirTher 1996;32:148-150; and

2. Daya, K, Bourcier, L, Singhal, N, McMillan, D. Administration of nitric oxide during neonatal transport.

### SUMMARY OF THE INVENTION

The within invention is directed at a kit, device or system for the delivery of a flow of a gas including at least one specialty gas. The system is intended for use with, and is connectable to, a gas delivery device having an output flow. Thus, the system delivers the gas from a gas source to the gas delivery device, preferably the output flow of the gas delivery device. More particularly, the system regulates and monitors the delivery of the gas flow and thus, regulates and monitors the delivery of the specialty gas or gases included within the gas flow. Preferably, the system regulates and monitors the delivery on a continuous basis. Further, the system is preferably designed such that it may be adapted for the regulation and monitoring of any specialty gas or gases within the gas flow.

In particular, the within invention is comprised of a system for regulating and monitoring the delivery of a flow of a gas from a gas source to an output flow of a gas delivery device, wherein the gas is comprised of at least one specialty gas, the system comprising:

(a) a delivery unit connectable with the gas source and the output flow of the gas delivery device for delivering the flow of the gas from the gas source to the output flow at an injection site defined thereby and wherein the delivery unit is comprised of an adjustable device for regulating the flow of the gas therethrough; and

(b) a sampling unit connectable with the output flow of the gas delivery device at a location downstream of the injection site for removing a gas sample from the output flow, wherein the sampling unit is comprised of a sample monitoring device for providing feedback on the composition of the gas sample.

The system, and preferably the delivery unit of the system, is connectable and usable with any gas source, being any source, supply or origin of the gas desired to be delivered by the within system. For instance, the gas source may be comprised of a large gas cylinder containing the desired gas, however, preferably the gas source is comprised of a small gas cylinder of a size such that the gas cylinder is portable or easily transportable. For instance, the gas cylinder preferably provides the gas, comprised of at least one specialty gas, in a relatively small volume, such as a volume of less than or equal to approximately 100 liters.

Further, the system, and preferably the delivery unit of the system, includes fittings or connectors which are compatible for connection with or to the gas source. These fittings or connectors preferably provide for a quick connect connection such that the gas source is easily changed by a relatively easy connection and disconnection from the delivery unit, as required or desired for any particular application.

Further, the gas provided or supplied by the gas source, and delivered by the within system, may be comprised of any gas desired to be delivered to a specific site, destination or patient, being any animal including a human. Further, the gas is comprised of at least one specialty gas, and more preferably, two or more specialty gases. A specialty gas is any gas particularly desired to be delivered for a particular purpose or to perform a specific function. Further, as the within system is particularly useful for administering or delivering the gas to a patient, the specialty gas is preferably a specialty medical gas or a gas found or believed to have particular application for the treatment or prophylaxis of medical conditions or diseases in need thereof.

For instance, in the preferred embodiment of the system, the gas is comprised of at least one specialty gas selected from the group consisting of oxygen, helium, nitrogen, nitric oxide, peroxynitrite, carbon dioxide, carbon monoxide and nitrogen dioxide. However, the specialty gas will be selected depending upon, amongst other factors, the particular purpose or function of the specialty gas, the needs of the patient to whom the gas is delivered and the other components or constituents comprising the gas to be delivered by the system.

As indicated, the system, and preferably the delivery unit, is also connectable and usable with any gas delivery device having an output flow. More particularly, the gas delivery device may be any device, mechanism or structure capable of delivering a gaseous flow to the desired site, destination or patient through an output flow. The output flow may be comprised of any structure, mechanism, device or member capable of directing the gaseous flow within or from the gas delivery device and outputting the gaseous flow to the desired site, destination or patient.

For example, for medical applications, the gas delivery device may be comprised of any device, structure or mechanism capable of providing a gas to either a mechanically-assisted ventilated patient or a spontaneously breathing patient. In each instance, the gas delivery device includes an output flow, being the inspiratory gas flow of the gas delivery device. Thus, the gas delivery device may be comprised of a ventilator, a mask or nasal cannula or the like.

Further, the system, and preferably the delivery unit of the system, includes fittings or connectors which are compatible for connection with or to the gas delivery device. These fittings or connectors preferably provide for a quick connect connection such that the system may be relatively easily connected to and disconnected from the delivery unit, as required or desired for any particular application.

Thus, in the preferred embodiment of the within system, the system is comprised of the delivery unit and the sampling unit. The delivery unit is connectable with the gas source and the gas delivery device such that the delivery unit delivers the flow of the gas from the gas source to the output flow of the gas delivery device. The particular location or position at which the gas flow is delivered to, or introduced into, the output flow defines an injection site. Preferably, this injection site is defined by the connection between the delivery unit and the gas delivery device.

Further, the delivery unit is comprised of an adjustable device for regulating, controlling or adjusting the flow of the gas through the delivery unit. Although any regulator or regulating device, mechanism or structure may be used, the adjustable regulating device of the delivery unit is preferably comprised of an adjustable valve for controlling the flow rate of the gas.

As well, the delivery unit is preferably further comprised of a gas flow monitoring device for providing feedback on the flow rate of the gas therethrough. The gas flow monitoring device may be comprised of any device, mechanism or structure capable of monitoring the flow rate of the gas and providing feedback to the user of the system on that flow rate. More preferably, the gas flow monitoring device is comprised of any device, mechanism or structure capable of measuring or otherwise determining the mass flow rate of the gas and providing feedback on that mass flow rate.

In the preferred embodiment, the gas flow monitoring device is comprised of a mass flow meter for determining a mass flow rate of the gas through the delivery unit. Further, the gas flow monitoring device may provide feedback on the mass flow rate measured or otherwise determined thereby in any manner or by any mechanism, device, structure or process capable of providing the desired feedback to the user of the system. However, in the preferred embodiment, the gas flow monitoring device is further comprised of an indicator for providing a feedback signal indicative of the mass flow rate of the gas.

Although any form of feedback or any form or type of feedback signal may be provided by the indicator, the feedback signal provided by the flow rate indicator is preferably comprised of at least one of a visual signal, an auditory signal and a mechanical signal. For instance, the visual signal may be provided by a light or other visual display. The auditory signal may be provided by any sound, while the mechanical signal may be by way of vibration. In the preferred embodiment, the flow rate indicator is comprised of a visual display for providing a visual feedback signal indicative of the mass flow rate of the gas.

In any event, the feedback signal may provide any level or degree of feedback as required for the particular application of the system. In the preferred embodiment, the feedback signal provides specific quantitative information on the flow rate, such as by providing a visual display of the specific mass flow rate as determined by the mass flow meter. However, alternately, the feedback signal may be provided by the specific absence or presence of a signal indicative of a preset or predetermined flow rate. For instance, a single visual feedback signal, such as the illumination of a single light, may be provided when the mass flow rate exceeds a preset or predetermined maximum desirable mass flow rate. Further, two or more lights may be provided, each of which is preset to illuminate when the mass flow rate is determined to be within a range of mass flow rates predetermined for that particular light.

The sampling unit of the system is connectable with the output flow of the gas delivery device for removing a gas sample from the output flow. More particularly, the sampling unit is connectable with the output flow at a location downstream of the injection site. In order for the system to monitor the delivery of the gas, and in particular the specialty gas or gases therein, it is desirable that the sampling unit remove or extract a gas sample from the output flow at a location or position downstream of the introduction or delivery of the gas to the output flow. In other words, the gas sample is removed from the output flow at a location or position downstream of the injection site, as defined above.

Thus, the gas, including at least one specialty gas, is delivered or introduced into the output flow of the gas delivery device at the injection site. Once introduced or injected therein, the gas mixes or intermingles with any gas or gases contained or included within the output flow of the gas delivery device. The sampling unit then removes a gas sample from the output flow downstream of the injection site. Thus, the gas sample necessarily includes both the gas from the delivery unit and any gas or gases mixed or intermingled therewith within the gas delivery device. In this manner, the sampling unit is able to monitor and provide feedback on the nature or characteristics of the gas as actually being provided to the site, destination or patient by the output flow of the gas delivery device.

Further, the sampling unit is comprised of a sample monitoring device for providing feedback on the composition of the gas sample. The feedback may relate to any desired quality, characteristic or feature of the gas sample desired to be monitored. However, preferably, the feedback relates to a quality, quantity or other characteristic of at least one specialty gas. More preferably, the sample monitoring device provides feedback on the quantity, being an amount or percentage, of at least one specialty gas in the gas sample.

Further, the sampling unit may remove, by extracting, withdrawing or drawing out in any manner or by any process, mechanism, structure or device, the gas sample in a discontinuous manner at random or predetermined intervals. However, preferably, the sampling unit removes, by extracting, withdrawing or drawing out in any manner or by any process, mechanism, structure or device, the gas sample continuously or on a continuous basis. Thus, the sample monitoring device may provide continuous feedback on the composition of the gas sample, such as the quantity of at least one specialty gas in the gas sample.

As indicated, the sampling unit is preferably comprised of the sample monitoring device which provides feedback on the composition of the gas sample, preferably the quantity of at least one specialty gas in the gas sample. The sample monitoring device may be comprised of any device, mechanism or structure capable of monitoring the composition of the gas sample, and preferably the quantity of the specialty gas therein, and providing the desired feedback on the gas sample to the user of the system. More preferably, the sample monitoring device is comprised of any device, mechanism or structure capable of measuring or otherwise determining the composition of the gas sample, and preferably the quantity of the specialty gas therein, and providing feedback thereon.

Preferably, the sample monitoring device is comprised of at least one sensor for determining the quantity of at least one specialty gas in the gas sample. However, in the preferred embodiment, the system is used for the delivery of at least two specialty gases in the gas. Thus, in the preferred embodiment, the sample monitoring device is comprised of at least two sensors for determining the quantity of at least two specialty gases in the gas sample. In other words, the number of sensors is selected to match or be compatible with the number of specialty gases desired to be delivered and monitored by the system.

Further, each sensor may be comprised of any device, mechanism or structure capable of, and compatible with, sensing, measuring or otherwise determining the quantity of the desired specialty gas in the gas sample. In addition, the system is preferably usable for regulating and monitoring the delivery of one or more specialty gases. In order that the system may be adapted for use with any desired specialty gas or gases, at least one sensor is preferably removable such that the sensor is selectable for determining the quantity of a desired specialty gas in the gas sample.

In other words, it is preferable that the within system not be limited for use with any particular specialty gas or gases. Thus, in order that the system may be adapted and modified as necessary for any desired use, at least one of the sensors is removable such that it may be removed, where no longer required, and exchanged or replaced with a sensor which is capable of, and compatible with, determining the quantity of the specific specialty gas desired to be measured by the user of the system. More preferably, as the system is preferably used for two or more specialty gases, at least two sensors are removable, wherein each sensor is selectable for determining the quantity of a desired specialty gas in the gas sample. In the preferred embodiment, all of the sensors are removable and interchangeable such that each sensor may be removed and exchanged for a sensor compatible with the particular desired use of the system and a particular specialty gas.

Further, the sample monitoring device may provide feedback on the quantity measured or otherwise determined by each sensor in any manner or by any mechanism, device, structure or process capable of providing the desired feedback to the user of the system. However, preferably, the sample monitoring device is further comprised of a quantity indicator for providing a feedback signal indicative of the quantity of at least one specialty gas in the gas sample. More preferably, the quantity indicator provides a feedback signal indicative of the quantity of each specialty gas in the gas sample. In the preferred embodiment, where there is greater than one sensor, the quantity indicator provides a feedback signal indicative of the quantity of each specialty gas determined by each sensor.

Although any form of feedback or any form or type of feedback signal may be provided by the quantity indicator, the feedback signal provided by the quantity indicator for each specialty gas is preferably comprised of at least one of a visual signal, an auditory signal and a mechanical signal. For instance, the visual signal may be provided by a light or other visual display. The auditory signal may be provided by any sound, while the mechanical signal may be by way of vibration. However, preferably, the quantity indicator is comprised of at least one visual display for providing a visual feedback signal indicative of the quantity of a particular specialty gas in the gas sample. In the preferred embodiment, the quantity indicator is comprised of at least two visual displays for providing a visual feedback signal indicative of the quantity of each specialty gas.

In any event, the feedback signal provided by the quantity indicator for each specialty gas may provide any level or degree of feedback as required for the particular application of the system. Preferably, at least one feedback signal, and more preferably two or more feedback signals, provide specific quantitative information on the quantity, such as an amount or percentage, of a particular desired specialty gas in the gas sample, such as by providing a visual display of the concentration of the specialty gas therein or the percentage of the gas sample comprised of the particular desired specialty gas.

However, alternately, the feedback signal may be provided by the specific absence or presence of a signal indicative of a preset or predetermined quantity. For instance, a single visual feedback signal, such as the illumination of a single light, may be provided when the quantity of a particular specialty gas in the gas sample exceeds a preset or predetermined maximum desirable quantity. A single light maybe provided for any number of the specialty gases. Further, two or more lights may be provided for each specialty gas, wherein each light is preset to illuminate when the quantity of the desired specialty gas is determined to be within a range of quantities predetermined or preset for that particular light.

In addition, in the preferred embodiment, the sampling unit is further comprised of a pump for conducting the gas sample therethrough to provide a gas sample flow. Any pump or pumping process, mechanism, device or structure capable of establishing the desired gas sample flow may be used. Further, in order that the gas sample flow may be regulated, the sampling unit is also further preferably comprised of an adjustable device for regulating, controlling or adjusting the flow of the gas sample through the sampling unit. Although any regulator or regulating device, mechanism or structure may be used, the adjustable regulating device of the sampling unit is preferably comprised of an adjustable valve for controlling the sample flow rate in order to provide a sample flow rate compatible with the determination of the specialty gas quantity by each sensor.

More particularly, the sampling unit is preferably further comprised of a manifold for diverting the gas sample flow across at least one sensor for the determination of the quantity of at least one specialty gas in the gas sample. In the preferred embodiment, the manifold diverts the gas sample flow across each sensor in order that the quantity of each desired specialty gas in the gas sample may be determined. Thus, the adjustable valve of the sampling unit preferably controls the sample flow rate through the sampling unit in order to provide a sample flow rate compatible with the determination of the specialty gas quantity by each sensor as the gas sample is diverted across the sensors by the manifold.

Finally, in the preferred embodiment, the system includes a safety mechanism or device wherein the sampling unit communicates with the delivery unit such that further operation of the delivery unit ceases or is discontinued when the sampling unit communicates to the delivery unit that the quantity of a particular specialty gas in the gas sample is either, or both, greater than or less than a preset or predetermined quantity of that specialty gas. Any device, structure or mechanism capable of performing this function and interfering with the continued gas flow through the delivery unit may be used.

However, in the preferred embodiment, the delivery unit is comprised of a flow interrupter, associated with the sample monitoring device, for preventing the flow of the gas through the delivery unit to the injection site when the quantity of at least one specialty gas in the gas sample is determined to be greater than a predetermined value.

Thus, in the preferred embodiment, this invention is directed at a flexible system or kit that addresses a variety of specialty gas delivery, regulating and monitoring needs. Preferably, the within invention is comprised of a kit, device or system for delivery of specialty gas, including the regulation and monitoring of that delivery, which includes at least one interchangeable sensor. Thus, the kit or system may be customized for one or more or multiple specialty gas combinations such as helium—oxygen, nitric oxide with nitrogen dioxide, peroxynitrite-nitrogen, or carbon monoxide with oxygen and/or nitric oxide and/or carbon dioxide. The system is further preferably designed to be compact, light in weight and easily transportable. Thus, the system preferably includes a self-contained enclosure. A soft-pack gas carrying case may also be provided for small volume high-pressure cylinders with easy to change quick connect fittings.

Finally, in the preferred embodiment, the within invention is comprised of a flexible, light weight, transportable, multi-gas regulating and monitoring delivery system which an be customized to meet the ever changing needs of the medical specialty gas delivery field. Several of the advantages associated with the preferred embodiment of the within kit or system are as follows: versatile and easily adaptable to multiple gas applications; relatively light weight and small in size such that it is easily transportable; self contained with a preferably hard protective enclosure; quick connect gas connections permitting connection to small volume delivery cylinders and large medical gas cylinders; preferably includes a PC computer interface tie in; and includes audible and visual alarm warnings, independent multiple gas concentration displays and a safety device or mechanism to prevent excess concentration of specialty gases.

More particularly, in the preferred embodiment, the invention is a portable multi-gas delivery kit, device or system. The system may be used within a hospital, but it has been found to be particularly useful for transport of a subject by land, air, or water ambulance. For instance, the system is useable with a variety of gas delivery devices or systems that provide breathing to a subject during transport. The entire kit or system is preferably carried in hand with a shoulder pack that contains the source of gas including the specialty gas or gases. The entire system, including the gas source, preferably weighs less than about 90 pounds, more preferably less than about 20 pounds. Further, the system preferably includes an enclosure containing or housing a multi-gas monitoring system, a high accuracy graduated metering device, a mass-flow meter, a flow-diverter, quick connector fittings, a multi-gas manifold that houses a variety of medical gas sensors and a small source gas cylinder.

The preferred embodiment of the system of the within invention is designed to be generic, in that it can function independently of the particular gas delivery device being used with the system. Titration of a user set flow of any specialty gas such as helium, carbon monoxide, carbon dioxide, nitric oxide or peroxynitrite, into the gas delivery device by the delivery unit of the within system results in an adulterated mixture within the output flow or inspiratory gas flow of the gas delivery device. The sensors of the sampling unit of the system preferably provide a visual feed-back to the user of the resulting gas constituency. The gas flow through the delivery unit from the gas source, which includes the specialty gases, may then be altered to attain an achievable desired quantity of the specialty gases, and particularly, to attain an achievable desired concentration of the specialty gases.

The device, kit or system is also preferably adaptable to provide for a variety of different monitoring, measuring or determining devices, apparatuses, techniques or methods. More particularly, the gas flow monitoring device of the delivery unit of the system may be comprised of any device, apparatus or structure capable of performing any desirable monitoring, measuring or determining technique, process or method for providing feedback on the gas flow including the specialty gas or gases. For instance, the gas flow monitoring device may be comprised of one or both of a chest inductance output and direct electrical feedback from the gas delivery device. This would allow the system to automatically adjust for any particular gas delivery device or equipment and to assure that the desired or proper specialty gas concentration is being administered regardless of its flow characteristics.

In addition, more particularly, the sample monitoring device of the sampling unit of the system may be comprised of any device, apparatus or structure capable of performing any desirable monitoring, measuring or determining technique, process or method for providing the desired or required feedback on the gas sample. For instance, the sample monitoring device may be comprised of a rapid response specialty gas analyzer.

### BRIEF DESCRIPTION OF THE SEVERAL VIEWS OF THE DRAWING

FIG. 1. is a schematic view of a preferred embodiment of the system of the within invention, in block diagram form;

FIG. 2. is a schematic view of a control panel, in block diagram form, of the preferred embodiment of the system shown in FIG. 1.

### DETAILED DESCRIPTION OF THE INVENTION

The preferred embodiment of the within invention is directed at a device, kit or system (20) which includes the use of a small gas cylinder providing a gas source (22), preferably less than about 100 liters. The gas cylinder supplying the gas source (22) provides high pressure compressed gas which is comprised of at least one specialty gas to the system (20). The gas source (22) is connected to the system (20) with quick connect connectors (24) and hoses. Quick connectors (24) are preferably used to ensure rapid change of source gas cylinders (22) without interruption of specialty gas flow. More particularly, the quick connectors (24) permit or provide for a minimal interruption of the gas flow from the gas source (22). A soft portable case with a shoulder strap (not shown) is preferably included to safely house the source specialty gas cylinder (22) and the associated cylinder pressure regulator (26). All wetted surfaces of the system (20) are preferably fabricated with non-corrosive surfaces for specialty medical gases.

The preferred embodiment of the system (20) includes a delivery unit (28) and a sampling unit (30), along with various displays (as discussed below), a power source (not shown) such as a rechargeable battery and a CPU (32). The CPU (32) is provided to monitor and control the other components of the system (20) as detailed below. Although any power source may be provided for the system (20), the power source is preferably comprised of an internal rechargeable battery, having about a 6-8 hour operation capability.

The system (20), including the delivery and sampling units (28, 30) and the portable case, is preferably of a weight permitting portably or readily easy transportability. In the preferred embodiment, the system (20) weighs less than about 20 pounds and is entirely portable. Further, the system (20) can preferably function for approximately 8 hours without connection to electrical mains. The preferred embodiment of the system (20), and in particular the delivery unit (28), is comprised of a high accuracy, graduated, adjustable regulating device (34) that allows the user to adjust the flow rate of the gas flow, including the specialty gas or gases, from the gas source (22) to an injection site (36) defined by an output flow (38) of a gas delivery device (40). The flow rate of the gas flow is verified by a gas flow monitoring device (41) which provides feedback on the flow rate of the gas therethrough. The gas flow monitoring device (41) is preferably comprised of a mass flow meter (42) for determining a mass flow rate of the gas therethrough and a flow rate indicator (44) providing a feedback signal indicative of the mass flow rate of the gas. In the preferred embodiment, the flow rate indicator (44) is comprised of visual digital display for providing a visual feedback signal indicative of the mass flow rate of the gas.

The sampling unit (30) of the system (20) removes or aspirates a low-flow gas sample, preferably less than 200 liters per minute, from the output flow (38) of the gas delivery device (40) at a location (46) downstream of the injection site (36) of the gas flow including the specialty gas. The gas sample from the output flow (38) is aspirated into the sampling unit (30), wherein the sampling unit is comprised of a sample monitoring device (48) for providing feedback on the composition of the gas sample, preferably the quantity, and particularly the concentration, of at least one specialty gas in the gas sample. The sampling unit (30) removes or aspirates the gas sample continuously so that the sample monitoring device (48) provides the feedback on a continuous basis.

The sample monitoring device (48) is comprised of at least one sensor, and preferably three sensors (50, 52, 54), for determining the quantity, and particularly the concentration, of various specialty gases in the gas sample. Each of the three sensors (50, 52, 54) may be provided for determining the quantity of any desired specialty gas, including but not limited to, oxygen, helium, nitric oxide, peroxynitrite, carbon dioxide, carbon monoxide and nitrogen dioxide.

In the preferred embodiment, the sensors (50, 52, 54) are housed or contained within a manifold (56). Further, the manifold (56) diverts the gas sample across at least one of the sensors (50, 52, 54), and preferably all of the sensors (50, 52, 54), in order to determine the concentration of each specialty gas therein.

Further, in the preferred embodiment, the sampling unit (30) is comprised of a quantity indicator (58), which displays the concentrations of the desired specialty gases. In other words, the quantity of the desired specialty gas or gases is indicated as a specialty gas concentration. Specifically, the quantity indicator (58) provides a feedback signal indicative of the quantity, and particularly the concentration, of each desired specialty gas in the gas sample. In the preferred embodiment with three sensors (50, 52, 54), the quantity indicator provides a feedback signal for each of three specialty gases. The feedback signal is preferably visual signal indicative of the concentration of the specialty gas. Thus, in the preferred embodiment, three visual displays (60, 62, 64) are provided such that the gas concentrations are displayed on the front face of the system (20).

As described further below, in the preferred embodiment, the system (20) also includes various controls, alarms and safety devices to prevent excess concentrations of either of two specialty gases in the administration to the subject, including means to divert and/or shut off the specialty gas flow to a desired safe level. The preferred embodiment may thus provide an alarm or other appropriate action in the event of an increase in either of the two specialty gases increasing beyond a predetermined level. Depending on the severity of the alarm condition, an alarm may activate or the entire system may be controlled to alleviate the unsafe condition encountered.

These and other objects, features and advantages of the present invention will be more apparent from the detailed description of the invention set forth below, taken in conjunction with accompanying drawings.

This invention will be used in diagnostic and/or therapeutic applications including human medical applications, research applications, commercial applications, industrial applications, and veterinary applications. It has further been found to be suitable for neonatal and pediatric applications.

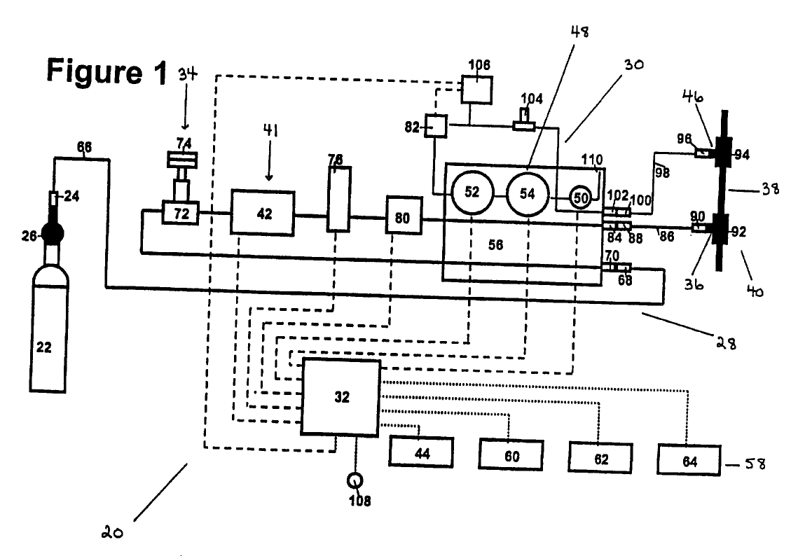

Referring to FIG. 1, a gas comprised of at least one specialty gas is supplied from the gas source (22), being a cylinder which may be either a small volume for portability purposes or a large volume for stationary purposes. The typical pressure within the cylinders is about 2000 psig. The concentration of each specialty gas within the gas provided by the gas source (22) is determined by the particular application. Specialty gases and specialty gas combinations include but are not limited to helium—oxygen, nitric oxide, peroxynitrite, peroxynitrite-nitrogen, nitric oxide-nitrogen, carbon monoxide-oxygen, carbon monoxide-nitric oxide, and carbon monoxide-carbon dioxide.

A cylinder pressure regulator (26) associated with the gas source (22) enables the gas delivery pressure to be controlled and reduced to approximately 55 psig. The gas then flows through a braided stainless steel Teflon-lined high pressure delivery line (66) terminated at both ends with quick connect fittings (24, 68). The high pressure delivery line (66) with quick connect fittings (24, 68) allows rapid, tool-free connection of the specialty source gas delivery cylinder (22) to an inlet quick connect fitting (70) housed in the gas manifold (56), just upstream of the control delivery valve (72) of the adjustable regulating device (34). All quick connect fittings are fabricated in stainless steel with non-corrosive seals for the particular specialty gas being delivered by the system (20). The main gas control delivery valve (72) is a stainless steel valve with Teflon™ packing, 13 turn stop to stop, with a vibration resistant knob (74). This delivery valve (72) allows accurate adjustment and control of the gas flow. The gas control delivery valve (72) is connected on the down stream side to the mass flow meter (42) by screwed npt stainless steel fittings and tubing. The mass flow meter (42) is preferably a zero to three litre per minute capacity mass flow measuring device constructed with a stainless steel body and seals. The meter (42) detects the flow of gas that is regulated though the delivery valve (72), and sends an electronic signal to a mass flow LED/LCD numeric display (44) via the central processing unit or CPU (32).

The delivery valve (72) is connected on the down steam side to a positive power to open, solenoid shut-off valve (76) which provides a positive discontinuation of gas flow when the operator selects the off position from the system operating switch (116), or when electrical power is inappropriately disrupted.

The solenoid shut-off valve (76) is connected on the down stream side to a flow interrupter, being a shut-off diverting valve (80) which functions as a shut-off valve when a high alarm condition exists for separately monitored gases. The shut-off diverting valve (80) receives input from sensors (52) and (54) which independently monitor selected specialty gas concentrations including but not limited to nitric oxide, nitrogen dioxide, oxygen, helium, carbon monoxide, carbon dioxide, or peroxynitrite. A second function of the shut-off diverting valve (80) is to act as a delivery line purge mechanism to allow system (20) purge prior to delivery under operating conditions. The third function of the shut-off diverting valve (80) is to react to the computer CPU (32) instruction to terminate gas flow. The shut-off diverting valve (80) is connected on the down stream side to the gas manifold (56) by screwed npt tubing and fittings.

In the preferred embodiment, the gas manifold (56) is a machined high tolerance acrylic multi-connection manifold which directs gas flow and houses various quick connect fittings, sensors (50, 52, 54), various valves and a sample pump (82). The manifold (56) preferentially diverts a sample gas flow across multiple gas sensors such as sensors (50, 52, 54). The manifold (56) is preferably designed to reduce weight, reduce production costs, optimize compatibility, allow for visual inspection, optimize serviceability, increase vibration resistance and reduce assembly time. For instance, the system (20) preferably meets United States of America military standards for medical devices. Further, the gas manifold (56) is preferably machined to within a tolerance of 1/1000 of an inch. An advantage in the design of the manifold (56) relating to gas sensing is that you get a lower gas sample volume with higher surface gas velocities across the sensors (50, 52, 54).

The gas manifold (56) directs flow from the shut-off diverting valve (80) to the screwed npt inlet of the stainless steel female by a positive locking connection delivery outlet fitting (84). The gas then flows through a 1/8 inch diameter PVC gas delivery line (86) connected on the upstream side by a male by a positive locking connection (88), and on the down steam side by a positive locking connection (90) to a delivery adapter (92), which preferably defines the injection site (36).

The delivery adapter (92) in combination with a downstream sample connector (94) provide the connection with the gas delivery device (40). Preferably, the downstream sample connector (94) defines the location (46) at which the gas sample is removed from the output flow (38) of the gas delivery device (40) to the sampling unit (30). Continuous monitoring of multi-gas concentrations utilizes interchangeable sensors (50, 52, 54).

This system (20) can be utilized as a sub-component in various other gas delivery devices (40), apparatuses or systems. The output flow (38) is defined by or comprised of a gas delivery line between the delivery adapter (92) and the downstream sample connector (94) and provides the interface point between the system (20) of the within invention and a variety of gas delivery devices (40). The physical distance between the delivery adapter (92) and the downstream sample connector (94) and thus, the length of this portion of the output flow (38), is optimized for gas mixing and delivery purposes within the output flow (38).

Gas samples enter the downstream sample connector (94) which is connected by a positive locking connection (96) to a gas sample line (98) connected on the upstream side by a male by a positive locking connection (96), and on the down steam side by a positive locking connection (100). The gas sample line (98) is preferably comprised of a liquid filter and Nafion™ water vapor filter (not shown) for the specific purpose of removing water vapor. A positive locking connection (102) connects the gas sample line (98) to the gas manifold (56) by a screwed npt connection.

The gas then flows through the gas manifold (56) into screwed npt tubing and fittings connected on the down stream side, which connect to an adjustable device for regulating the flow of the gas sample therethrough, preferably an adjustable sample line metering valve (104). The sample line metering valve (104) is a stainless a steel valve with Teflon™ packing which allows fine adjustment of the sample pump (82) and controls the sampling gas flow rate. Preferably, the sampling unit (30) provides for a sampling gas flow rate of less than about two hundred liters per second.

The sample line metering valve (104) is connected to a down stream pressure sensor (106) by screwed npt tubing and fittings. The pressure sensor (106) monitors the gas flow in the sample line and controls the sample pump (82) by shutting it down in specific low flow conditions. It also communicates with the computer CPU (32) and initiates a check sample line indicator LED (108).

Down stream of the metering valve (104) and pressure sensor (106) is the sample pump (82). The sample pump (82) delivers a consistent sample of gas through the manifold (56) and across the sensors (50, 52, 54). The sensors (50, 52, 54) are connected directly to the manifold (56) by a press-fit o-ring connection. Gas sensors (50, 52, 54) are interchangeable and can sense specific specialty gases including but not limited to oxygen, helium, nitric oxide, peroxynitrite, carbon dioxide, carbon monoxide and nitrogen dioxide.

All gas concentrations measurements by the sensors (50, 52, 54) are electronically signaled to the CPU (32) and are displayed on the LED/LCD numeric displays (60, 62, 64). Down stream of the sensors (50, 52, 54) and as an integral and final component of the manifold (56), is a sample gas exhaust outlet (110).

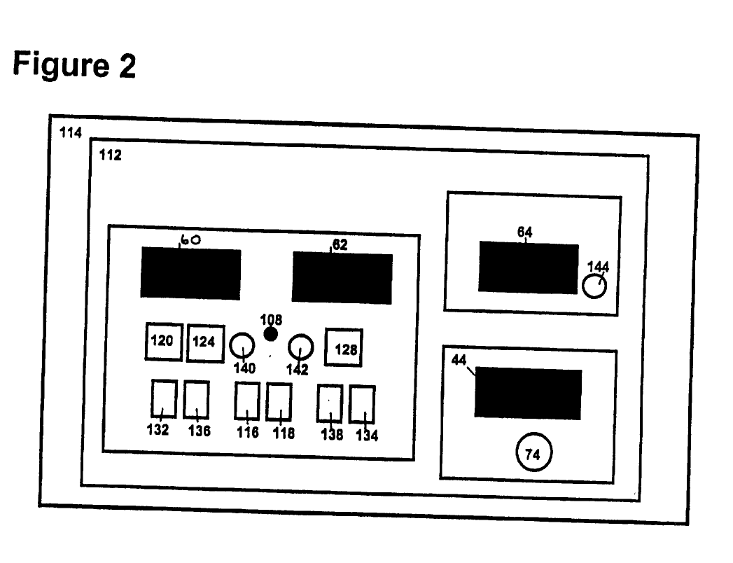

Referring to FIG. 2, the main display and control panel (112) is visible on the top of the system enclosure housing (114). Switch (116) turns the power on to the system (20). Switch (118) activates back lighting on the LED/LCD numeric displays (60, 62, 64). The control panel (112) provides all manual switches and visual indicators necessary to control and monitor gas delivery.

The internal main gas control delivery valve (72) is controlled by the vibration resistant knob (74). The system (20) detects the flow of gas that is regulated though the internal delivery valve (72), and sends an electronic signal to the mass flow LED/LCD numeric display (44) via the internal CPU (32).

All gas concentrations measurements by the internal sensors (52, 54, 50) are electronically signaled to the CPU (32) and are displayed on the LED/LCD numeric displays (60, 62, 64) respectively. LED/LCD numeric displays (60, 62) are back-lit, digital liquid crystal displays which show gas concentrations in ppm, calibration status and battery condition.

A “plug” character in the display indicates that the wall power is connected and that the system (20) is charging. Adjustable thumb-wheel (120) sets the visual LED alarm (60) and internal audible alarm setting for the internal sensor (52) under low conditions. Adjustable thumb-wheel (124) sets the visual LED alarm (60) and internal audible alarm setting for the internal sensor (52) under high conditions. Adjustable thumb-wheel (128) sets the visual LED alarm (62) and internal audible alarm setting for the internal sensor (54) under high conditions.

The internal pressure sensor (106) monitors the gas flow in the sample line and controls the internal sample pump (82) by shutting it down in specific low flow conditions. It also communicates with the computer CPU (32) and initiates the check sample line indicator LED (108). Switch (132) initiates a one minute audible alarm silence period for low or high alarm conditions of the internal sensor (52). Switch (134) initiates a one minute audible alarm silence period for a high alarm condition of the internal sensor (54). Switch (136) automatically zeros the corresponding sensor (52) reading on the LED/LCD numeric display (60) and displays “DONE” when zeroed. This switch (136) must be held in continuously for a period of 5 seconds. Switch (138) automatically zeros the corresponding sensor (54) reading on the LED/LCD numeric display (62) and displays “DONE” when zeroed. This switch (138) must be held in continuously for a period of 5 seconds.

Turning potentiometer (140) adjusts the LED/LCD numeric display (60) to calibrate the analyzer against a known reference gas source. Turning potentiometer (142) adjusts the LED/LCD numeric display (62) to calibrate the analyzer against a known reference gas source. Turning potentiometer (144) adjusts the LED/LCD numeric display (64) to calibrate the analyzer against a known reference gas source.

The embodiments of the invention in which an exclusive privilege or property is claimed are defined as follows:

1. A system for regulating and monitoring the delivery of a flow of a gas from a gas source to an output flow of a gas delivery device, wherein the gas is comprised of at least one specialty gas, the system comprising:
(a) a delivery unit connectable with the gas source and the output flow of the gas delivery device for delivering the flow of the gas from the gas source to the output flow at an injection site defined thereby and wherein the delivery unit is comprised of an adjustable device for regulating the flow of the gas therethrough; and
(b) a sampling unit connectable with the output flow of the gas delivery device at a location downstream of the injection site for removing a gas sample from the output flow, wherein the sampling unit is comprised of a sample monitoring device for providing feedback on the composition of the gas sample.

2. The system as claimed in claim 1 wherein the adjustable regulating device of the delivery unit is comprised of an adjustable valve for controlling the flow rate of the gas.

3. The system as claimed in claim 2 wherein the delivery unit is further comprised of a gas flow monitoring device for providing feedback on the flow rate of the gas therethrough.

4. The system as claimed in claim 3 wherein the gas flow monitoring device is comprised of a mass flow meter for determining a mass flow rate of the gas through the delivery unit and a flow rate indicator for providing a feedback signal indicative of the mass flow rate of the gas.

5. The system as claimed in claim 4 wherein the feedback signal provided by the flow rate indicator is comprised of at least one of a visual signal, an auditory signal and a mechanical signal.

6. The system as claimed in claim 5 wherein the flow rate indicator is comprised of a visual display for providing a visual feedback signal indicative of the mass flow rate of the gas.

7. The system as claimed in claim 1,2, 3, 4, 5 or 6 wherein the sample monitoring device provides feedback on the quantity of at least one specialty gas in the gas sample.

8. The system as claimed in claim 7 wherein the sampling unit removes the gas sample continuously and wherein the sample monitoring device provides continuous feedback on the quantity of at least one specialty gas in the gas sample.

9. The system as claimed in claim 8 wherein the sample monitoring device is comprised of at least one sensor for determining the quantity of at least one specialty gas in the gas sample and a quantity indicator for providing a feedback signal indicative of the quantity of the specialty gas in the gas sample.

10. The system as claimed in claim 9 wherein at least one sensor is removable such that the sensor is selectable for determining the quantity of a desired specialty gas in the gas sample.

11. The system as claimed in claim 10 wherein the feedback signal provided by the quantity indicator for each specialty gas is comprised of at least one of a visual signal, an auditory signal and a mechanical signal.

12. The system as claimed in claim 11 wherein the quantity indicator is comprised of at least one visual display for providing a visual feedback signal indicative of the quantity of the specialty gas in the gas sample.

13. The system as claimed in claim 9 wherein the sample monitoring device is comprised of at least two sensors for determining the quantity of at least two specialty gases in the gas sample and wherein the quantity indicator provides a feedback signal indicative of the quantity of each specialty gas in the gas sample.

14. The system as claimed in claim 13 wherein at least two sensors are removable such that each sensor is selectable for determining the quantity of a desired specialty gas in the gas sample.

15. The system as claimed in claim 14 wherein the feedback signal provided by the quantity indicator for each specialty gas is comprised of at least one of a visual signal, an auditory signal and a mechanical signal.

16. The system as claimed in claim 15 wherein the quantity indicator is comprised of at least two visual displays for providing a visual feedback signal indicative of the quantity of each specialty gas.

17. The system as claimed in claim 10 wherein the sampling unit is comprised of a pump for conducting the gas sample therethrough to provide a gas sample flow and wherein the sampling unit is comprised of an adjustable device for regulating the flow of the gas sample therethrough.

18. The system as claimed in claim 17 wherein the sampling unit is further comprised of a manifold for diverting the gas sample flow across at least one sensor for the determination of the quantity of at least one specialty gas in the gas sample.

19. The system as claimed in claim 18 wherein the adjustable regulating device of the sampling unit is comprised of an adjustable valve for controlling the sample flow rate in order to provide a sample flow rate compatible with the determination of the specialty gas quantity by each sensor.

20. The system as claimed in claim 8, 9, 10, 11, 12, 13, 14, 15, 16, 17, 18 or 19 wherein at least one specialty gas is selected from the group consisting of oxygen, helium, nitrogen, nitric oxide, peroxynitrite, carbon dioxide, carbon monoxide and nitrogen dioxide.

21. The system as claimed in claim 8 , 9, 10, 11, 12, 13, 14, 15, 16, 17, 18 or 19 wherein the delivery unit is further comprised of a flow interrupter, associated with the sample monitoring device, for preventing the flow of the gas through the delivery unit to the injection site when the quantity of at least one specialty gas in the gas sample is determined to be greater than a predetermined value.
